(19) United States
(12) Patent Application Publication
(10) Pub. No.: US 2024/0375383 A1
(43) Pub. Date: Nov. 14, 2024

(54) CELLULOSE BASED BOTTOM WEB AND PACKAGE MADE THEREFROM

(71) Applicant: Cryovac, LLC, Charlotte, NC (US)

(72) Inventors: Robert Babrowicz, Tega Cay, SC (US); Dylan Hopkins, Charlotte, NC (US); Robert Scott Corey, Tega Cay, SC (US); Edward Moore, Mount Holly, NC (US)

(21) Appl. No.: 18/686,900

(22) PCT Filed: Aug. 26, 2022
(86) PCT No.: PCT/US2022/041634

§ 371 Date: Feb. 27, 2024

Related U.S. Application Data
(60) Provisional application No. 63/237,568, filed on Aug. 27, 2021.

(51) Int. Cl. B32B 27/10; B32B 27/32; B65B 25/00; B65D 81/20

(52) U.S. Cl. CPC B32B 27/10; B32B 27/32; B65B 25/001; B65D 81/2015; B32B 2255/12; B32B 2255/26; B32B 2307/514; B32B 2307/538; B32B 2307/54; B32B 2307/5825; B32B 2307/718; B32B 2307/7244; B32B 2307/7376; B32B 2307/738; B32B 2439/70

(57) ABSTRACT

A cellulose based bottom web, package made therefrom and method for manufacture. The bottom is primarily made from cellulose based material. The bottom web having a seal layer on its surface. The seal layer being mostly made from polymeric material. The bottom web being semi-rigid and thermoformable. The bottom web having between 80-99.5 wt % cellulose based material and 0.5-20 wt % polymeric material. A flexible top web is sealed to the bottom web to form a package.

### CROSS-REFERENCE TO RELATED APPLICATIONS

This application claims priority to U.S. Provisional Patent Application Ser. No. 63/237,568, filed Aug. 27, 2021 and entitled “Cellulose Based Bottom Web and Package Made Therefrom,” the entirety of which is incorporated herein by reference.

### BACKGROUND

The subject matter disclosed herein relates to a cellulose based bottom web having layers of thermoplastic materials and cellulose based materials. More particular, the subject matter disclosed herein relates to, an article or product is enclosed between two webs, or layers, of material forming vacuum skin package and a method for manufacturing such package.

In the packaging of food products, such as fresh seafood (non-frozen), if the packaging material does not have a relatively high oxygen transmission rate (“OTR”), under certain conditions the result can be the growth of Clostridium botulinum, which can produce illness for a consumer of the seafood. The United States Food and Drug Administration sets a standard for the packaging of seafood because of the risk of growth of Clostridium botulinum. Under the standard, for fresh seafood that is packaged in a reduced oxygen package (e.g. vacuum packages, MAP where oxygen levels are lower than atmospheric levels, etc.), the packaging film must have an oxygen (i.e., O₂) transmission rate of at least 10,000 cc at standard temperature and pressure (STP)/m²/day/1 atm at 23 C at 0% RH (relative humidity) measured according to ASTM 3985.

One method of packaging food products is by vacuum skin packaging. In general, a vacuum skin package is formed by having a support and a product (such as a food product) loaded onto the support. A top web is heated and then molded down upon and around the product and against the support. The space between the heated top web and the support having been evacuated. The top web forms a tight skin around the product and is sealed to the surface of the support not covered by the product, by differential air pressure. Vacuum skin packaging is described in more detail in for example, U.S. Pat. No. 3,835,618, to Richard Perdue, entitled “Apparatus for Producing Vacuum Skin Package in Multiples”, and U.S. Pat. No. 6,042,913, to Miranda et al, entitled “Vacuum Skin Package and Composite Film Therefor”, both of which are hereby incorporated, in their entireties, by reference thereto.

The discussion above is merely provided for general background information and is not intended to be used as an aid in determining the scope of the claimed subject matter.

### BRIEF DESCRIPTION

A cellulose based bottom web, package made therefrom and method for manufacture. The bottom is primarily made from cellulose based material. The bottom web having a seal layer on its surface. The seal layer being mostly made from polymeric material. The bottom web being semi-rigid and thermoformable. The bottom web having between 80-99.5 wt % cellulose based material and 0.5-20 wt % polymeric material. A flexible top web is sealed to the bottom web to form a package.

An advantage that may be realized in the practice of some disclosed embodiments of the cellulose based bottom web is utilization of more sustainable materials in the packaging. Another advantage that may be realized is use of a permeable bottom web to allow for selection of a wider range of possible top web options.

In one exemplary embodiment, a packaging article is disclosed. The packaging article having a flexible top web and a semi-rigid thermoformable bottom web. The bottom web being a multilayer structure comprising: i) a first cellulose layer being a majority portion of cellulose based material; and ii) a seal layer being a majority portion of polymeric material. The bottom web having between 80-99.5 wt % cellulose based material and 0.5-20 wt % polymeric material as compared to the total weight of the bottom web. The flexible top web is sealed to the seal layer of the bottom web.

In another exemplary embodiment, a process for packaging a product is disclosed. The process comprising the steps of: i) situating a product onto a semi-rigid thermoformable bottom web; and ii) sealing a flexible top web to at least a portion of the seal layer of the bottom web. The bottom web being a multilayer structure comprising: i) a first cellulose layer being a majority portion of cellulose based material; and ii) a seal layer being a majority portion of polymeric material. The bottom web having between 80-99.5 wt % cellulose based material and 0.5-20 wt % polymeric material as compared to the total weight of the bottom web.

In another exemplary embodiment, a method of making a bottom web is disclosed. The method comprises the steps of providing a first semi-rigid thermoformable cellulose layer and coating a seal layer onto a surface of the first cellulose layer to form a bottom web. The cellulose layer being a majority portion of cellulose based material. The seal layer being a majority portion of polymeric material. The bottom web having between 80-99.5 wt % cellulose based material and 0.5-20 wt % polymeric material as compared to the total weight of the bottom web.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary multilayer bottom web according to an embodiment;

FIG. 2 is an exemplary multilayer bottom web according to an embodiment;

FIG. 3 is an exemplary multilayer bottom web with a plurality of cavities;

FIG. 4 are exemplary vacuum skin packages with a product disposed between a flexible top web and a multilayer bottom web;

FIG. 5 is an exemplary process for manufacturing a multilayer bottom web according to some embodiments;

FIG. 6 is an image of a dye test prior to submersion into a dye; and

FIG. 7 is an image of a dye test after to submersion into a dye and drying.

### DETAILED DESCRIPTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 2.5 mils, or from 1 to 2.5 mils, or from 1.5 to 2.5 mils.

The film may be a monolayer or multi-layer film and may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

As used herein, the term “support” or “bottom web,” which may be used interchangeably, means a rigid or semi-rigid web or sheet. As used herein the term “rigid” are materials that have a modulus of elasticity either in the machine direction (MD) and/or the traverse direction (TD) greater than 100,000 psi at 23° C. and 50% relative humidity when tested in accordance with ASTM D-882 “Standard Test Method for Tensile Properties of Thin Plastic Sheeting” the contents of which are incorporated herein by reference. As used herein the term “semi-rigid” are materials having medium modulus of elasticity either in the machine direction (MD) and/or the traverse direction (TD) of between 10,000 and 100,000 psi at 23° C. and 50% relative humidity when tested in accordance with ASTM D-882. As used herein the term “flexible” are materials having medium modulus of elasticity either in the machine direction (MD) and/or the traverse direction (TD) of less than 10,000 psi at 23° C. and 50% relative humidity when tested in accordance with ASTM D-882.

In a typical skin packaging process, a sheet of thermoplastic film (also referred to as a “top web”) is placed in a frame positioned over a vacuum plate upon which a support (such as a backing board or tray) has been placed. The product to be skin packaged is positioned on top of the support and heat is applied to the thermoplastic film in the frame. When the film has been heated to become sufficiently soft, the support is lowered, and the plastic sheet drapes itself over the product. As this happens, a partial vacuum is created through the vacuum plate and the air underneath the film is withdrawn through the support. The air pressure differential between the top and the bottom of the plastic sheet causes the sheet to be tightly pressed around the product. In an embodiment, the support remains level and the upper portions, lower portions, or both close around the support.

The film may be coated with an adhesive or the support may be so coated. Where the two contact each other, a strong bond is formed resulting in a package in which the product is tightly held to the support for safe shipping and for subsequent rack display in retail stores.

Vacuum skin packaging processes generally employ a vacuum chamber with an open top. The product is placed on a substrate and the substrate is placed on a platform within a vacuum chamber. The top of the chamber is then covered by a sheet of film which is clamped tightly against the chamber to form a vacuum type closure. The chamber is evacuated while the film is heated to forming and softening temperatures. The platform can then be raised, or the film can be lowered to drive the product into the softened film and air pressure can be used above the film to force it tightly around the product. In some processes a primary seal is made around the perimeter of the substrate on a sealing bar or dome by pressing a heated seal bar or dome directly onto the film. In other processes, seals are made solely by heating the films against a hot dome and using vacuum pressure differential to force the heated film onto the substrate. The vacuum skin package process is useful for the packaging of food products, including, but not limited to meat, cheese and fresh seafood.

In an embodiment, the seal bar or dome operates at a temperature range from 150° C. to 230° C. In another embodiment, the seal bar or dome operates at a temperature range from 170° C. to 220° C.

In one embodiment a vacuum skin package is made by clamping a film with tooling. The film is draw up against a hot dome or on to multiple individual seal heads in a preformed tray machine tool. The seal heads may be flat or dome shaped. Dome shapes may be greater than 10 mm. In another embodiment, the dome shapes are greater than 25 mm. The film is heated and then either draped over a product or blow down on the product with the pressure difference between the area above the film as compared to the area below the film.

In another embodiment a vacuum skin package is made by process of loading a product in a tray. The product loaded tray is loaded into a vacuum chamber and film is positioned above the product and tray. The vacuum chamber evacuates air from above the film to bring it into contact with a heating plate to heat the film. Evacuating air from within the tray through either at least one hole or from below the film. Introducing air from above the film pushes the film into contact with the product. The film is then welded to the inner surface of the tray closing any holes.

Food products that can be packaged in a include a vacuum skin package described herein include, but are not limited to cheese, beef, birds such as poultry (including chicken, duck, goose, turkey, and the like), buffalo, camel, crustacean (including shellfish, clams, scallops, mussels, oysters, lobster, crayfish, crab, shrimp, prawns, and the like), fish (including salmon, trout, eel, cod, herring, plaice, whiting, halibut, turbot, ling, squid, tuna, sardines, swordfish, dogfish, shark, and the like), game (including deer, eland, antelope, and the like), game birds (such as pigeon, quail, doves, and the like), goat, hare, horse, kangaroo, lamb, marine mammals (including whales and the like), amphibians (including frogs and the like), monkey, pig, rabbit, reptiles (including turtles, snakes, alligators, and the like), and/or sheep.

In embodiments described herein the food product is a seafood product. In embodiments, the seafood product is a fresh seafood product. The term “fresh seafood product” refers to a non-frozen food product that is perishable and wherein the internal temperature has not been below −2° C.

When packaging fresh seafood products, a high oxygen transmission rate is used to reduce the risk of Clostridium botulinum. The term “oxygen transmission rate” or “OTR” is measured according to ASTM D3985 (latest version as the filing of this disclosure), a test known to those of ordinary skill in the art, and which is hereby incorporated by reference in its entirety. Unless otherwise stated, oxygen transmission rate values provided herein are measured at 0% relative humidity and at a temperature of 23° C.

When packaging fresh seafood products, the United States Food and Drug Administration requires the package to have an oxygen transmission rate of at least 10,000 cc at standard temperature and pressure (STP)/m²/day/1 atm at 23° C. at 0% RH (relative humidity) measured according to ASTM 3985. Other jurisdictions outside of the United States are known to have different requirements.

The bottom web as described herein has an oxygen transmission rate of at least 8,000 cc (STP)/m²/day/1 atm at 23° C. at 0% RH measured according to ASTM 3985 without perforating the bottom web. In an embodiment, the bottom web has an oxygen transmission rate of at least 9,000 cc (STP)/m²/day/1 atm at 23° C. at 0% RH measured according to ASTM 3985 without perforating the bottom web. In an embodiment, the bottom web has an oxygen transmission rate of at least 10,000 cc (STP)/m²/day/1 atm at 23° C. at 0% RH measured according to ASTM 3985 without perforating the bottom web. In some embodiments, the bottom web has an oxygen transmission rate of any of the following: at least 11,000 cc (STP)/m²/day/1 atm; at least 12,000 cc (STP)/m²/day/1 atm; at least 13,000 cc (STP)/m²/day/1 atm; at least 14,000 cc (STP)/m²/day/1 atm; at least 15,000 cc (STP)/m²/day/1 atm; at least 16,000 cc (STP)/m²/day/1 atm; at least 17,000 cc (STP)/m²/day/1 atm; at least 18,000 cc (STP)/m²/day/1 atm; at least 19,000 cc (STP)/m²/day/1 atm; at least 20,000 cc (STP)/m²/day/1 atm; at least 21,000 cc (STP)/m²/day/1 atm; at least 25,000 cc (STP)/m²/day/1 atm; at least 50,000 cc (STP)/m²/day/1 atm; at least 75,000 cc (STP)/m²/day/1 atm; at least 100,000 cc (STP)/m²/day/1 atm. Oxygen transmission rate may be tested on a bottom web sheet, or on a thermoformed tray. In embodiments at least one layer of the bottom web is non-perforated. In embodiments, all layers of the bottom web are non-perforated.

The bottom web consists of multiple layers. The bottom web having a seal layer and a cellulose layer. In embodiments the bottom web further includes at least one polymeric layer.

Below are some examples of combinations in which the alphabetical symbols designate the bottom web layers. It is understood that addition cellulose or polymeric layers can be included to form a bottom web beyond what is listed in the non-limiting examples below. Where the multilayer bottom web representation below includes the same letter more than once, each occurrence of the letter may represent the same composition or a different composition within the class that performs a similar function.
A/B, A/B/C, A/C/B, A/B/C/B, A/C/B/C/B, A/C/B/C/B/C, A/B/C/B/C, A/C/B/C/B/C/B, A/B/C/B/C/B, A/C/B/C/B/C/B/C, A/B/C/B/C/B/C.
“A” represents a seal layer, as discussed herein.
“B” represents a cellulose layer, as discussed herein.
“C” represents a polymeric layer, as discussed herein

The cellulose layer is layer primary made from cellulose material such as cellulose fibers. The cellulose layer is sufficiently stretchable and has adequate rigidity to be utilized as a bottom web in vacuum skin packaging applications. The bottom web having sufficient rigidity to support a product. In embodiments, the bottom web has sufficient stretchability to create a container having a cavity to receive a product therein.

In embodiments, the cellulose layer has a stretchability according to ISO 1924-3:2005, the contents of which are incorporated herein by reference, of at least 3, 5, 7, 12 or 14% in the machine direction (MD) and/or the traverse direction (TD). In embodiments, the cellulose layer has a stretchability according to ISO 1924-3:2005 of at least 6% in the machine direction (MD) and at least 6% in the traverse direction (TD). For example, the stretchability may be at least 7% percent in both directions (MD and TD). In embodiments, the stretchability according to ISO 1924-3:2005 is at least 9% in at least one of the machine direction (MD) and the traverse direction (TD). In embodiments having multiple cellulose layers, the stretchability (ISO 1924/3) of at least one other layer may be below 5 or 3% in the machine direction (MD) and/or the traverse direction (TD).

A non-limiting example of a suitable material for the cellulose layer is paperboard such as FibreForm® marketed by BillerudKorsnas AB (Sweden). In FibreForm®, the stretchability is at least 7% in the TD and at least 13% in the MD.

In an embodiment, the grammage of the cellulose layer is 40-600 g/m². In an embodiment, the grammage of the cellulose layer is 60-500 g/m². In an embodiment, the grammage of the cellulose layer is 80-400 g/m². In an embodiment, the grammage of the cellulose layer is 100-300 g/m². In an embodiment, the grammage of the cellulose layer is 150-250 g/m². In embodiments, a single cellulose layer does not provide sufficient rigidity. As such, multiple cellulose layers may be used to achieve a total grammage of the support of any of the following ranges 200-1000 g/m², 250-800 g/m², or 300-600 g/m². All grammage values are measured in accordance with ISO 536:2012, the contents of which are incorporated by reference in their entirety.

In embodiments the total thickness of the cellulose layer(s) is 200-1000 μm. Each individual cellulose layer may have a thickness of any of the following ranges, 100-1000 μm, 200-800 μm, 300-600 μm, or 150-400 μm. The thickness being measured according to ISO 534:2011, the contents of which are incorporated by reference.

In embodiments the tensile strength of the cellulose layer is at least any of 8, 10, or 12 kN/m in the MD and at least any of 4, 5, or 6 kN/m in the TD. Tensile strength of the cellulose layer is measured on accordance with ISO 1924-3:2005 the contents of which are incorporated by reference in their entirety.

The tear strength of the cellulose layer in the MD is at least any of 1500, 1800 or 2100 mN. The tear strength of the cellulose layer in the TD is at least any of 2100, 2600 or 3100 mN. The tear strength of the cellulose layer is measured according to ISO 1974:2012 the contents of which are incorporated by reference in their entirety.

The cellulose layer has a Tensile Energy Absorption, of at least any of 300, 500, 600, 700 or 800 J/m² in the MD and at least any of, 200, 300 or 400 J/m² in the CD. Tensile Energy Absorption of the cellulose layer is measured according to ISO 1924-3:2005 the contents of which are incorporated by reference in their entirety.

In embodiments the bottom web is between 80 and 95 wt % cellulose material as compared to the total weight of the bottom web. Cellulose material includes cellulose fibrous and non-fibrous materials. The bottom web is further made up of between 5 and 20 wt % polymeric materials as compared to the total weight of the bottom web.

The thickness of the cellulose layer, or layers if multiple layers are present in the bottom web, as a percentage of the total thickness of the bottom web may be more that any of the following values: 90%, 92%, 93%, 94% and 95%; and may range between any of the forgoing values (e.g., from 92% to 95%). The bottom web is made mostly from the material in the cellulose layer(s). In embodiments, the bottom web comprising between 80-99.5 wt % cellulose based material and 0.5-20 wt % polymeric material as compared to the total weight of the bottom web. In embodiments, the bottom web comprises between at least any of the following amounts 80, 85, 90, 95 or 99.5 wt % cellulose based material as compared to the total weight of the bottom web. In embodiments, the bottom web comprises less than any of the following amounts 20, 15, 12, 10, 8, 6, 5, 4, 3, 2, 1, or 0.5 wt % polymeric material as compared to the total weight of the bottom web.

The seal layer (also referred to as a “heat seal layer”) is an outer layer or layers of the bottom web. The seal layer seals the bottom web to another layer of another film, and/or another article which is not a film, such as a tray or substrate. It should also be recognized that in general, up to the outer 0.25-30 μm of a web can be involved in the sealing of the bottom web. The heat seal layer frequently also serving as a food contact layer in the packaging of foods. In general, sealant layers employed in the packaging art have included thermoplastic polymers, such as polyolefin, polyamide, polyester, and polyvinyl chloride. In an embodiment, the seal layer is at least 50, 60, 70, 80, 90, 95, or 99 wt %, as compared to the seal layer, of materials selected from the group of polyolefins, ethylene/vinyl acetate copolymers, ionomers, ethylene/alkyl acrylate copolymer, ethylene/(meth)acrylic acid copolymers and blends thereof. In an embodiment, the seal layer is substantially all polyolefin.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like.

Seal layers include thermoplastic polymers, including, but not limited to thermoplastic polyolefin, polyamide, polyester, and polyvinyl chloride. In embodiments, polymers for the seal layer include homogeneous ethylene/alpha-olefin copolymer, heterogeneous ethylene/alpha-olefin copolymer, ethylene homopolymer, and ethylene/vinyl acetate copolymer. In some embodiments, the seal layer can comprise a polyolefin, particularly an ethylene/alpha-olefin copolymer. For example, a polyolefin having a density of from 0.88 g/cc³ to 0.917 g/cc³, or from 0.90 g/cc³ to 0.917 g/cc³, or less than 0.92 g/cc³. More particularly, the seal layer can comprise at least one member selected from the group consisting of high density polyethylene, linear low density polyethylene, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

In an embodiment, the heat seal layer comprises a polymer having a melting point of from 30° C. to 150° C., in another embodiment from 60° C. to 125° C., and in yet another embodiment from 70° C. to 120° C. All references to the melting point of a polymer, a resin, or a film layer in this application refer to the melting peak temperature of the dominant melting phase of the polymer, resin, or layer as determined by differential scanning calorimetry according to ASTM D-3418, the contents of which are incorporated by reference. In embodiments where the heat seal layer comprises amorphous material, then the heat seal layer may not clearly display a melting point. The glass transition temperature for the heat seal layer may be less than, and may range between, any of the following values: 125° C., 120° C., 110° C., 100° C., 90° C., 80° C., 70° C., 60° C., and 50° C.; measured where the relative humidity may be any of the following values: 100%, 75%, 50%, 25%, and 0%. All references to the glass transition temperature (Tg) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

The seal layer is primarily made from polymeric materials. In embodiments, the polymeric material in the seal layer is at least 90, 95, 98 or 99 wt % in relation to the total weight of the seal layer materials selected from the group of polyolefins, ethylene/vinyl acetate copolymers, ionomers, ethylene/alkyl acrylate copolymer, ethylene/(meth)acrylic acid copolymers and blends thereof. In one embodiment, the polyolefin is a low density, or linear low density ethylene/alpha-olefin copolymer having a density of less than 0.92 g/cc³.

In an embodiment, the heat seal layer has a thickness of less than 50 μm. In an embodiment, the heat seal layer has a thickness of between 0.25-50 μm. In an embodiment, the heat seal layer has a thickness of between 0.5-40 μm. In an embodiment, the heat seal layer has a thickness of between 0.1-30 μm. In an embodiment, the heat seal layer has a thickness of less than any of the following values, 50, 45, 40, 35, 30, 25 or 20 μm. The thickness of the seal layer as a percentage of the total thickness of the bottom may be less that any of the following values: 10%, 9%, 8%, 7%, 6% and 5%; and may range between any of the forgoing values (e.g., from 8% to 6%).

In an embodiment, one or more polymers in the seal layer have a melt flow rate of from 1 to 50 g/10 min, 3 to 40 g/10 min, 5 to 30 g/10 min, or 8 to 20 g/10 min, at 190° C. and 2.16 kg measured in accordance with ASTM D1238, the contents of which are incorporated herein by reference.

The seal layer may be directly adhered to a cellulose layer without any intervening layer. In embodiments, a polymeric layer such as tie layer may be utilized between the seal layer and the cellulose layer. A “tie layer” refers to any inner layer having the primary purpose of adhering two layers to one another. Tie layers can comprise any polymer having a polar group thereon, or any other polymer which provides sufficient interlayer adhesion to adjacent layers comprising otherwise non-adhering, or weak adhering polymers. Tie layers include, but are not limited to, polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer and hot melt adhesives.

Seal refers to any seal of a first portion (i.e., region) of a film or web surface to a second portion of a film or web surface, wherein the seal is formed by heating the portions to at least their respective seal initiation temperatures and allowing contact between the portions.

In embodiments where multiple cellulose layers are used, a polymeric layer is used to adhere the cellulose layers together. In embodiments, the polymeric layer seals the cellulose layers together with a force greater than the force required to separate the fibrous material of the cellulose layer. In an embodiment, the polymeric layer is substantially similar to the seal layer described herein.

The support includes at least one cellulose layer and at least one seal layer. In embodiments, the bottom support further includes a polymeric layer. The polymeric layer may be on the surface of the cellulose layer opposite the seal layer to provide protection from the environment. In an embodiment a polymeric layer is disposed between two cellulose layers. In order to maintain the oxygen transmission rate disclosed herein, the polymeric layer is selected from materials and has the appreciate thickness so as not to lower the oxygen transmission rate below the desired levels.

The polymeric layer is primarily made from polymeric materials. In embodiments, the polymeric material in the seal layer is at least 90, 95, 98 or 99 wt %, in relation to the total weight of the polymeric layer, materials selected from the group of polyolefins, ethylene/vinyl acetate copolymers, ionomers, ethylene/alkyl acrylate copolymer, ethylene/(meth)acrylic acid copolymers and blends thereof. In one embodiment, the polyolefin is a low density, or linear low density ethylene/alpha-olefin copolymer having a density of less than 0.92 g/cc³.

In an embodiment, the polymeric layer has a thickness of less than 50 μm. In an embodiment, the polymeric layer has a thickness of between 0.25-50 μm. In an embodiment, the polymeric layer has a thickness of between 0.5-40 μm. In an embodiment, the polymeric layer has a thickness of between 0.1-30 μm. In an embodiment, the polymeric layer has a thickness of less than any of the following values, 50, 45, 40, 35, 30, 25 or 20 μm. The thickness of the polymeric layer as a percentage of the total thickness of the bottom may be less that any of the following values: 10%, 9%, 8%, 7%, 6% and 5%; and may range between any of the forgoing values (e.g., from 8% to 6%).

In embodiments the bottom web has thermoplastic properties. These properties allow for the formation of a package component having a three-dimensional shape. Such as by press-forming the support to obtain a three-dimensional shape having a cavity to support a product. In the press-forming operation, the material may be heated to a temperature of 70-220° C., 70-200° C., 80-160° C., or 80-140° C. In embodiments the bottom web has modulus of elasticity either or both the machine or transverse directions of between 10,000 and 100,000 psi at 23° C. and 50% relative humidity when tested in accordance with ASTM D-882. In embodiments the bottom web has modulus of elasticity either or both the machine or transverse directions of between 11,000 and 40,000 psi at 23° C. and 50% relative humidity when tested in accordance with ASTM D-882. In embodiments the bottom web has modulus of elasticity either or both the machine or transverse directions of between 12,000 and 20,000 psi at 23° C. and 50% relative humidity when tested in accordance with ASTM D-882. In embodiments the bottom web has modulus of elasticity either or both the machine or transverse directions of between 10,000 and 40,000 psi at 23° C. and 50% relative humidity when tested in accordance with ASTM D-882.

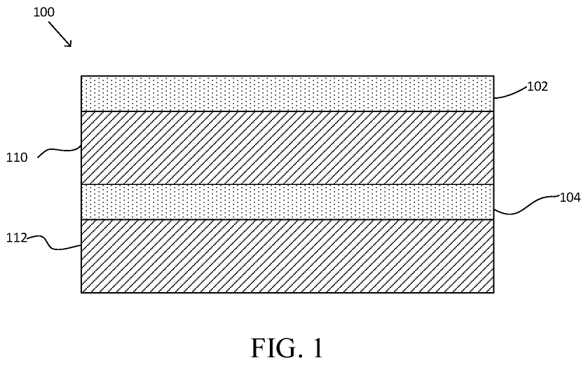

Turning now to FIG. 1, an exemplary multilayer bottom web 100 is shown. The bottom web 100 includes a seal layer 102 disposed upon a first cellulose layer 110. A polymeric layer 104 is disposed between a second cellulose layer 112. In embodiments the polymeric layer 104 is the same or substantially similar in compositions and/or thickness to the seal layer 102. FIG. 1 depicts the polymeric layer 104 is directly adhered to the first cellulose layer 110 and the second cellulose layer 112. In embodiments not depicted, additional layers may be disposed between the polymeric layer and at least one of the cellulose layers. In embodiments the polymeric layer and seal layer as extrusion coated onto the cellulose layers. It is understood that other methods for disposing the polymeric layer and seal layer are contemplated, such as via lamination (solvent or water based). In embodiments, the bottom web has a thickness of between 400-800 μm.

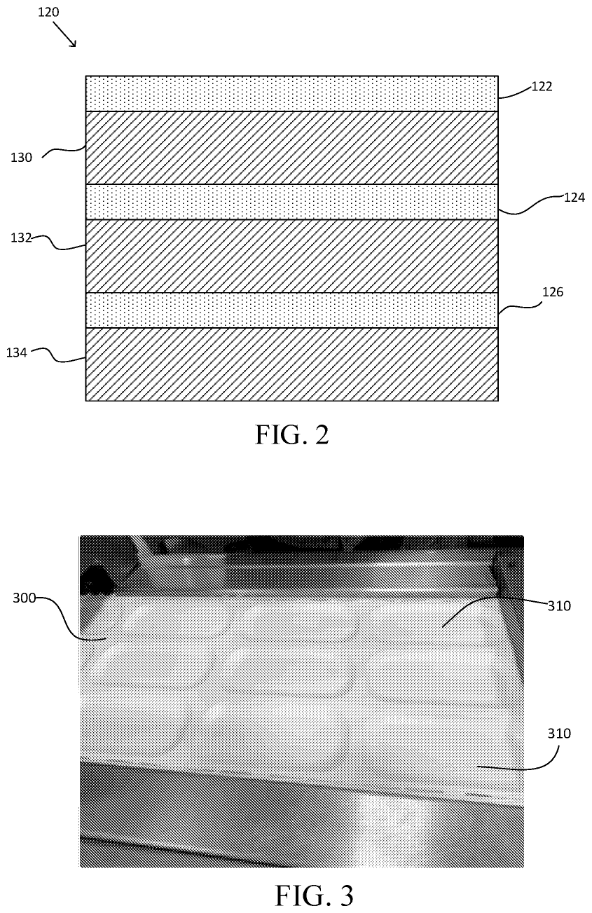

The bottom web may include any number of cellulose layers as described herein. As shown in FIG. 2, two polymeric layers 124 and 126 are disposed between cellulose layers 130, 132 and 134. A heat seal layer 122 is disposed on cellulose layer 130. The bottom web 120 having three cellulose layers, two polymeric layers and a heat seal layer. In embodiments at least one of the polymeric layers 124 and 126 is the same or substantially similar in compositions and/or thickness to the seal layer 122. In embodiments, at least one of the polymeric layers 124 and 126 are perforated while the seal layer 122 is a continuous, non-perforated layer.

The bottom web can be used as a flat sheet or a cavity can be created to form a three-dimensional bottom web, such as a tray. As shown in FIG. 3 a bottom web 300 is used to create a plurality of trays by forming cavities 310 with a flange created around the perimeter of the cavities 310. Tooling can be utilized to thermoform the cavities 310 into the bottom web 300. The bottom web can then be cut into a plurality of trays either before or after packaging. While multiple cavities are depicted in FIG. 3, it is understood that any number of cavities, including a single cavity is contemplated.

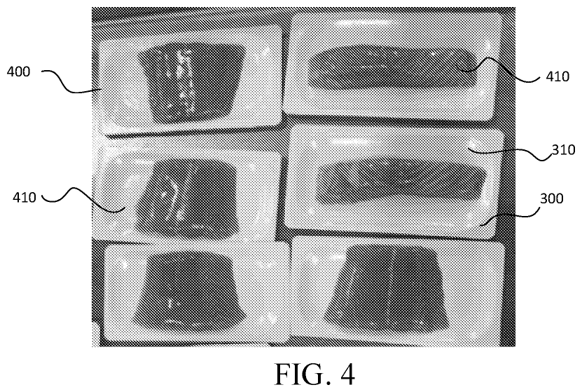

FIG. 4 depicts a plurality of packaged products 400. A product 410 is placed in cavity 310 of the bottom web 300. A flexible top web 410 covers the product 410 and forms to the portion of the bottom web 300 not covered by the product 410. After the top web 410 is provided, a vacuum skin packaging process is used to form the plurality of packaged products 400. In embodiments, the product is a food product. The individual packaged products 400 may be cut from the bottom web either before or after the vacuum skin packaging process.

The top web is a flexible multilayer material. In embodiments, the top web is suitable for use in vacuum skin packaging applications. Typical top web films comprise an outer sealant layer an outer heat-resistant layer opposite the sealant layer. Additional layers are provided to optionally provide toughness, abuse resistance, thermal transfer, bulk or barrier properties.

Suitable polymers for the sealant layer include but are not limited to thermoplastic polyolefin, polyamide, polyester, and polyvinyl chloride. In embodiments, polymers for the sealant layer include homogeneous ethylene/alpha-olefin copolymer, heterogeneous ethylene/alpha-olefin copolymer, ethylene homopolymer, and ethylene/vinyl acetate copolymer. In some embodiments, the sealant layer can comprise a polyolefin, particularly an ethylene/alpha-olefin copolymer. For example, a polyolefin having a density of from 0.88 g/cc³ to 0.917 g/cc³, or from 0.90 g/cc³ to 0.917 g/cc³, or less than 0.92 g/cc³. More particularly, the sealant layer can comprise at least one member selected from the group consisting of high density polyethylene, linear low density polyethylene, medium density polyethylene, low density polyethylene, very low density polyethylene, homogeneous ethylene/alpha-olefin copolymer, and polypropylene and blends thereof.

Common polymers for the outer heat-resistant layer are for instance ethylene homo- or co-polymers, ethylene/cyclic-olefin copolymers, such as ethylene/norbomene copolymers, propylene homo- or co-polymers, neutralized ethylene/(meth)acrylic acid copolymers, polyesters, polyamides.

Depending on the product to be packaged, the skin film may comprise a gas barrier layer. The gas barrier layer may comprise oxygen impermeable resins like PVDC, EVOH, polyamides and blends of EVOH and polyamides.

The film may also comprise other layers such as adhesive layers, bulk layers and the like to provide the necessary thickness to the film and improve the mechanical properties thereof, such as puncture resistance, abuse resistance, formability and the like.

The skin film may be obtained by any suitable co-extrusion process, either through a flat or a round extrusion die, by cast co-extrusion or by hot-blown. The skin film, or only one or more of the layers thereof, may be cross-linked to for example improve the strength of the film and/or the heat resistance when the film is brought in contact with the heating platen during the vacuum skin packaging process.

In embodiments, the top web has a high oxygen transmission rate. For example, a top web having an oxygen transmission rate of at least any of the following 8,000; 9,000; 10,000; 11,000; or 12,000 cc (STP)/m2/day/1 atm at 23° C. at 0% RH measured according to ASTM 3985. When paired with a bottom web having a high oxygen transmission rate, oxygen transmission rates of the top web are less important. As such, films with lower oxygen transmission rates can be utilized and good machinability and processability can be prioritized for top web selection. This results in the top web having a lower oxygen transmission rate than the bottom web. In embodiments, the top web is a barrier film. In other embodiments, the top web is a monolayer film comprising at least 90, 95, 98 or 99 wt %, in relation to the total weight of the top web, materials selected from the group of polyolefins, ethylene/vinyl acetate copolymers, ionomers, ethylene/alkyl acrylate copolymer, ethylene/(meth)acrylic acid copolymers and blends thereof.

Suitable films for use as top web films in the vacuum skin packaging are for instance those sold by Cryovac® under the trade names TS201®, TH300®, VST™0250, VST™0280, VS834, VS836, VT846, VF310K2 which comprise a sealant layer consisting of LDPE or LLDPE, VST™0291, TH301®, which comprise a sealant layer consisting of a neutralized ethylene/methacrylic acid copolymer, VS934, VS936 which comprise a sealant layer consisting of EVA sealant and VA835 which comprise an ionomer sealant. Some of which are available as barrier and non-barrier films. Monolayer films having good seal properties are further contemplated.

The outer sealant layers of the bottom web and the top web may be sealed to each other with a peel strength of at least 2 N/25.4 mm.

The vacuum skin package can be made by a conventional vacuum skin package process and using conventional vacuum skin package equipment, such as a Multivac® CD 6000 machine wherein a bottom web is thermoformed in-line with the vacuum skin packaging process.

A vacuum skin packaging process may use preformed containers, such as dishes, trays, bowls or the like, comprising a suitable material, for example comprising or consisting any of the structures described herein. Once the product has been arranged into the tray, the product loaded tray is placed in a vacuum skin package equipment for the skin packaging cycle. Conventional machines to carry out this alternative process are for instance a Mondini® E340 or a Multivac® T200.

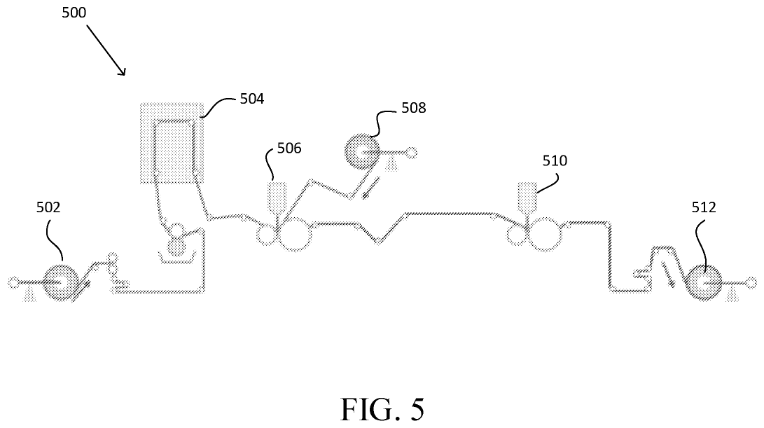

FIG. 5 depicts an extrusion process for making the bottom web described herein. The extrusion process 500 includes a wound roll of cellulose material 502. The cellulose material is optionally sent through a temperature controlled section 504. The temperature controlled section can raise or lower the temperature of the cellulose material. An extruder 506 extrudes a polymeric material onto the cellulose material. A second wound roll of cellulose material 508 is provided such that they polymeric material is disposed between two webs of cellulose material. An extruder 510 coats a seal layer onto the surface of one of the webs of cellulose material. As the seal layer cools the bottom web is optionally wound up in the winder 512. the polymeric material cools.

### Examples

A bottom web was made in the process depicted in FIG. 5 and as described above. The materials used are shown in Table 1.

TABLE 1

| | Generic | Trade | | Grammage | Density |
|---|---|---|---|---|---|
| Code | Name | Name | Supplier | g/m³ | g/cm³ |
| LDPE1 | Low | EC850 | Westlake | | 0.91 |
| | Density | | Chemical | | |
| | Polyethylene | | | | |
| KP1 | Kraft Paper | Fibre | Billerudkornas | 200 | |
| | | Form | | | |
| | | 200 | | | |

KP1 having the properties as listed in Table 2.

TABLE 2

| Property | Unit | | | Method |
|---|---|---|---|---|
| Grammage | g/m² | | 200 | ISO 536 |
| Caliper | μm | | 260 | ISO 536 |
| Stretch | % | MD | 14 | ISO 1924-3 |
| | % | TD | 10 | |
| Tensile Strength | kN/m | MD | 15 | ISO 1924-3 |
| | kN/m | TD | 8 | |
| Tear Strength | mN | MD | 3400 | ISO 1974 |
| | mN | TD | 5000 | |
| Tensile Energy | J/m² | MD | 1130 | ISO 1924-3 |
| Absorption | | TD | 580 | |
| Roughness | ml/min | | 3300 | ISO 8791/2 |
| Brightness | % | | 84 | ISO 2470 |
| Moisture | % | | 8 | ISO 287 |

A bottom web having the structure as shown in Table 3 we produced by extrusion coating.

TABLE 3

| Bottom | | | Thickness |
|---|---|---|---|
| web | Layer | Composition | (μm) |
| WEB1 | 1 (seal) | 100 wt % | 17.8 |
| | | LDPE1 | |
| | 2 | 100 wt % | 203 |
| | | KP1 | |
| | 3 | 100 wt % | 17.8 |
| | | LDPE1 | |
| | 4 | 100 wt % | 203 |
| | | KP1 | |

The bottom web provided good properties for use in food packaging as demonstrated in Table 4.

TABLE 4

| Impact | Test (Units) | WEB1 |
|---|---|---|
| Tensile at Break | ASTM D882 (psi) | 8480 |
| (TD) | | |
| Tensile at Break | ASTM D882 (psi) | 4680 |
| (MD) | | |
| Elongation at Break | ASTM D882 (%) | 20 |
| (TD) | | |
| Elongation at Break | ASTM D882 (%) | 12 |
| (MD) | | |
| Modulus (TD) | ASTM D882 (×1000 psi) | 17 |
| Modulus (MD) | ASTM D882 (×1000 psi) | 18.5 |
| Impact Peak | ASTM D7192 (N) | 432 |
| Impact Total Energy | ASTM D7192 (J) | 2.17 |
| Oxygen | ASTM 3985 | 188,500 |
| Transmission Rate | (cc (STP)/m2/day/1 atm | |
| | at 23° C. at 0% RH) | |

The bottom web provided good physical characteristics to perform as a thermoformable bottom web. The bottom web also has sufficient oxygen transmission rate to comply with current FDA requirements for packaging of fresh seafood products.

It is believed that the polymeric layer further provides a benefit of protecting the product and part of the package from damage from moisture.

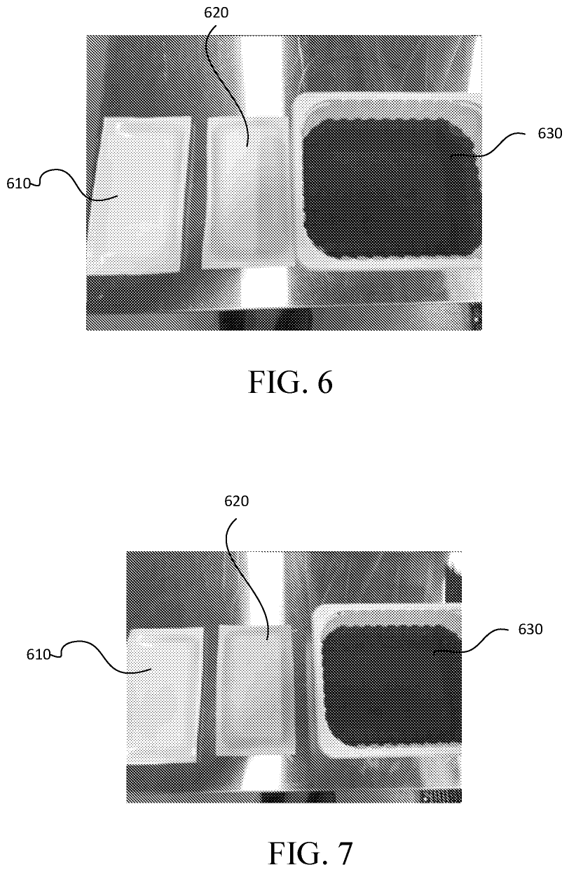

WEB1 was formed into trays having a cavity as depicted in FIG. 3. As shown in FIGS. 6-7, the trays were submerged into a red dye solution 630 to show moisture uptake within the layers of the bottom web. FIG. 6 depicts trays 610 and 620 before being submerged into the red dye solution 630. FIG. 7 depicts the same trays 610 and 620 after being submerged into the red dye solution 630 and allowed to dry. The seal side layer of the tray 610, considered the top side is shown. The bottom side of the tray 620 has a cellulous layer as the outermost layer and is shown in FIGS. 6-7.

The trays 610 and 620 were submerged into a red dye solution 630 completely for 10 seconds to allow for full potential uptake. After submersion, trays 610 and 620 were set out to air dry proving that moisture was only absorbed through the bottom layer and that the upper layer remained dry. The trays were allowed to dry for 20 minutes at 70° F. and 20-30% RH. At which time the moisture had evaporated leaving only the red pigment to appear.

As shown in FIG. 7, the bottom cellulose layer took up the red dye which remained after drying demonstrated by tray 620. The top cellulose layer remained dry with no red dye as demonstrated by tray 610. The polymeric layer disposed between the two cellulose layers was an effective moisture barrier.

Non-limiting embodiments include:

A. A packaging article comprising:
a. a flexible top web;
b. a semi-rigid thermoformable bottom web, the bottom web being a multilayer structure comprising:
   i. a first cellulose layer comprising a majority portion of cellulose based material; and
   ii. a seal layer comprising a majority portion of polymeric material;
the bottom web comprising between 80-99.5 wt % cellulose based material and 0.5-20 wt % polymeric material as compared to the total weight of the bottom web, wherein the top web is sealed to the seal layer of the bottom web.

B. The packaging article of embodiment A wherein the top web is a multilayer film comprising a sealant layer.

C. The packaging article of embodiments A-B wherein the bottom web has an oxygen transmission rate of at least any of the following 8,000; 9,000; 10,000; 11,000; 12,000; 15,000; 20,000; 25,000; 50,000; or 100,000 cc (STP)/m²/day/1 atm at 23° C. at 0% RH measured according to ASTM 3985.

D. The packaging article of embodiments A-C wherein the top web has an oxygen transmission rate of at least any of the following 8,000; 9,000; 10,000; 11,000; or 12,000 cc (STP)/m²/day/1 atm at 23° C. at 0% RH measured according to ASTM 3985.

E. The packaging article of embodiments A-C wherein the top web has an oxygen transmission rate that less than the oxygen transmission rate of the bottom web.

F. The packaging article of embodiments A-E wherein the polymeric material in the seal layer comprises at least 90, 95, 98 or 99 wt %, in relation to the total weight of the seal layer, materials selected from the group consisting of polyolefins, ethylene/vinyl acetate copolymers, ionomers, ethylene/alkyl acrylate copolymer, ethylene/(meth)acrylic acid copolymers and blends thereof.

G. The packaging article of embodiment F wherein the polymeric material in the seal layer is a low density, or linear low density ethylene/alpha-olefin copolymer having a density of less than 0.92 g/cc³.

H. The packaging article of embodiments A-G wherein the bottom web has modulus of elasticity of between 10,000 and 40,000 psi at 23° C. and 50% relative humidity measured in accordance with ASTM D882.

I. The packaging article of embodiments A-H wherein the bottom web further comprises a second cellulose layer and a first polymeric layer disposed between the first cellulose layer and the second cellulose layer.

J. The packaging article of embodiment I wherein the first polymeric layer comprises at least 90, 95, 98 or 99 wt %, in relation to the total weight of the first polymeric layer, materials selected from the group consisting of polyolefins, ethylene/vinyl acetate copolymers, ionomers, ethylene/alkyl acrylate copolymer, ethylene/(meth)acrylic acid copolymers and blends thereof.

K. The packaging article of embodiment I wherein the first polymeric layer is the same thickness and composition as the seal layer.

L. The packaging article of embodiments A-K wherein the seal layer has a thickness of less than 50 μm, or less than 40 μm, or less than 30 μm, or less than 25 μm, or less than 20 μm.

M. The packaging article of embodiment I wherein the first polymeric layer has a thickness of less than 50 μm, or less than 40 μm, or less than 30 μm, or less than 25 μm, or less than 20 μm.

N. The packaging article of embodiments A-M wherein the thickness of the seal layer as a percentage of the total thickness of the bottom may be less that any of the following values: 10%, 9%, 8%, 7%, 6% and 5%.

O. The packaging article of embodiment I wherein the thickness of the first polymeric layer as a percentage of the total thickness of the bottom may be less that any of the following values: 10%, 9%, 8%, 7%, 6% and 5%.

P. The packaging article of embodiments A-O wherein the first cellulose layer of the bottom web is a paperboard.

Q. The packaging article of embodiments A-P wherein the bottom web has a cellulose grammage of 300-600 gram/m² as measured in accordance with ISO 536:2012.

R. The packaging article of embodiments A-R wherein the first cellulose layer of the bottom web comprises a fibrous cellulose material.

S. The packaging article of embodiments A-R wherein the bottom web has a thickness of between 400-800 μm.

T. The packaging article of embodiments A-T further comprising a food product disposed between the top web and the bottom web.

U. The packaging article of embodiment T wherein the food product is a fresh seafood product.

V. The packaging article of embodiments A-V wherein the packaging article is a vacuum skin package.

W. The packaging article of embodiments A-V wherein the top web is monolayer film comprising at least 90, 95, 98 or 99 wt %, in relation to the total weight of the top web, materials selected from the group consisting of polyolefins, ethylene/vinyl acetate copolymers, ionomers, ethylene/alkyl acrylate copolymer, ethylene/(meth)acrylic acid copolymers and blends thereof.

X. The packaging article of embodiments A-W wherein the bottom web comprises less than 15, 12, 10, 8, 6, 4 or 2 wt % polymeric material as compared to the total weight of the bottom web.

Y. The packaging article of embodiments A-Y wherein the bottom web is a tray comprising:
a flange; and
a cavity for receiving a product.

AA. A process for packaging a product comprising the steps of:
a. situating a product onto a semi-rigid thermoformable bottom web;
   the bottom web being a multilayer structure comprising:
      i. a first cellulose layer comprising a majority portion of cellulose based material; and
      ii. a seal layer comprising a majority portion of polymeric material;
b. sealing a flexible top web to at least a portion of the seal layer of the bottom web
   the bottom web comprising between 80-99.5 wt % cellulose based material and 0.5-20 wt % polymeric material as compared to the total weight of the bottom web.

BB. The process for packaging a product according to embodiment AA wherein the bottom web is tray comprising a flange; and a cavity for receiving the product.

CC. The process for packaging a product according to embodiments AA-BB wherein step of sealing is done with a pressure differential to form a vacuum skin package wherein the top web is sealed to the flange and a portion of the cavity not covered by the product.

DD. The process for packaging a product according to embodiments AA-CC wherein the bottom web has an oxygen transmission rate of at least any of the following 8,000; 9,000; 10,000; 11,000; 12,000; 15,000; 20,000; 25,000; 50,000; or 100,000 cc (STP)/m²/day/1 atm at 23° C. at 0% RH measured according to ASTM 3985.

EE. The process for packaging a product according to embodiments AA-DD wherein the polymeric material in the seal layer comprises at least 90, 95, 98 or 99 wt %, in relation to the total weight of the seal layer, materials selected from the group consisting of polyolefins, ethylene/vinyl acetate copolymers, ionomers, ethylene/alkyl acrylate copolymer, ethylene/(meth)acrylic acid copolymers and blends thereof.

FF. The process for packaging a product according to embodiments AA-EE wherein the bottom web has modulus of elasticity of between 10,000 and 40,000 psi at 23° C. and 50% relative humidity measured in accordance with ASTM D882.

GG. The process for packaging a product according to embodiments AA-FF wherein the bottom web further comprises a second cellulose layer and a first polymeric layer disposed between the first cellulose layer and the second cellulose layer.

HH. The process for packaging a product according to embodiment GG wherein the first polymeric layer is the same thickness and composition as the seal layer.

II. The process for packaging a product according to embodiments AA-HH wherein the seal layer has a thickness of less than 50 μm, or less than 40 μm, or less than 30 μm, or less than 25 μm, or less than 20 μm.

JJ. The process for packaging a product according to embodiments AA-II wherein the thickness of the seal layer as a percentage of the total thickness of the bottom may be less that any of the following values: 10%, 9%, 8%, 7%, 6% and 5%.

KK. The process for packaging a product according to embodiment GG wherein the thickness of the first polymeric layer as a percentage of the total thickness of the bottom may be less that any of the following values: 10%, 9%, 8%, 7%, 6% and 5%.

LL. The process for packaging a product according to embodiments AA-KK wherein the bottom web has a cellulose grammage of 300-600 gram/m² as measured in accordance with ISO 536:2012.

MM. The process for packaging a product according to embodiments AA-LL wherein the product is a fresh seafood product.

NN. The process for packaging a product according to embodiments AA-MM wherein the bottom web comprises less than 15, 12, 10, 8, 6, 4 or 2 wt % polymeric material as compared to the total weight of the bottom web.

OO. A method for making a bottom web comprising the steps of:
a. providing a first semi-rigid thermoformable cellulose layer; and
b. coating a seal layer onto a surface of the first semi-rigid thermoformable cellulose layer to form a bottom web;
   the first semi-rigid thermoformable cellulose layer comprising a majority portion of cellulose based material;
   the seal layer comprising a majority portion of polymeric material;
the bottom web comprising between 80-99.5 wt % cellulose based material and 0.5-20 wt % polymeric material as compared to the total weight of the bottom web.

PP. The method of embodiment OO further comprising the steps of
a. providing a second semi-rigid thermoformable cellulose layer; and
b. extruding a polymeric layer between the first semi-rigid thermoformable cellulose layer and the second semi-rigid thermoformable cellulose layer to create a bottom web having at least two semi-rigid thermoformable cellulose layers.

QQ. The method of embodiment PP wherein the polymeric layer is directly adjacent to the first semi-rigid thermoformable cellulose layer and the second semi-rigid thermoformable cellulose layer.

RR The method of embodiments OO-QQ wherein the coating of the seal layer is an extrusion coated layer.

SS. The method of embodiments OO-RR further comprising the step of thermoforming the bottom web to form a tray comprising a flange; and a cavity for receiving a product.

TT. The method of embodiments OO-SS wherein the bottom web has an oxygen transmission rate of at least any of the following 8,000; 9,000; 10,000; 11,000; 12,000; 15,000; 20,000; 25,000; 50,000; or 100,000 cc (STP)/m²/day/1 atm at 23° C. at 0% RH measured according to ASTM 3985.

UU. The method of embodiments OO-TT wherein the polymeric material in the seal layer comprises at least 90, 95, 98 or 99 wt %, in relation to the total weight of the seal layer, materials selected from the group consisting of polyolefins, ethylene/vinyl acetate copolymers, ionomers, ethylene/alkyl acrylate copolymer, ethylene/(meth)acrylic acid copolymers and blends thereof.

VV. The method of embodiments OO-UU wherein the bottom web has modulus of elasticity of between 10,000 and 40,000 psi at 23° C. and 50% relative humidity measured in accordance with ASTM D882.

WW. The method of embodiment PP wherein the polymeric layer is the same thickness and composition as the seal layer.

XX. The method of claims embodiments OO-WW wherein the seal layer has a thickness of less than 50 μm, or less than 40 μm, or less than 30 μm, or less than 25 μm, or less than 20 μm.

YY. The method of embodiments OO-XX wherein the thickness of the seal layer as a percentage of the total thickness of the bottom may be less that any of the following values: 10%, 9%, 8%, 7%, 6% and 5%.

ZZ. The method of embodiment PP wherein the thickness of the first polymeric layer as a percentage of the total thickness of the bottom may be less that any of the following values: 10%, 9%, 8%, 7%, 6% and 5%.

AB. The method of embodiments OO-ZZ wherein the bottom web has a cellulose grammage of 300-600 gram/m² as measured in accordance with ISO 536:2012.

AC. The method of embodiments OO-AB wherein the bottom web comprises less than 15, 12, 10, 8, 6, 4 or 2 wt % polymeric material as compared to the total weight of the bottom web.

All references to (and incorporations by reference of) ASTM and ISO protocols are to the most-recently published ASTM and ISO procedure as of the priority (i.e., original) filing date of this patent application in the United States Patent Office unless stated otherwise.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. For example, while vacuum skin packaging is disclosed as the use for the bottom web in some embodiments, the bottom web described herein is useful for use in modified atmosphere packaging and as a roll stock.

1. A packaging article comprising:
a. a flexible top web;
b. a semi-rigid thermoformable bottom web, the bottom web being a multilayer structure comprising:
i. a first cellulose layer comprising a majority portion of cellulose based material; and
ii. a seal layer comprising a majority portion of polymeric material;
the bottom web comprising between 80-99.5 wt % cellulose based material and 0.5-20 wt % polymeric material as compared to the total weight of the bottom web, wherein the top web is sealed to the seal layer of the bottom web.

2. The packaging article of claim 1 wherein the top web is a multilayer film comprising a sealant layer.

3. The packaging article of claim 1 wherein the bottom web has an oxygen transmission rate of at least 8,000 cc (STP)/m²/day/1 atm at 23° C. at 0% RH measured according to ASTM 3985.

4. The packaging article of claim 1 wherein the top web has an oxygen transmission rate that less than the oxygen transmission rate of the bottom web.

5. The packaging article of claim 1 wherein the polymeric material in the seal layer comprises at least 90 wt %, in relation to the total weight of the seal layer, materials selected from the group consisting of polyolefins, ethylene/vinyl acetate copolymers, ionomers, ethylene/alkyl acrylate copolymer, ethylene/(meth)acrylic acid copolymers and blends thereof.

6. The packaging article of claim 1 wherein the bottom web has modulus of elasticity of between 10,000 and 40,000 psi at 23° C. and 50% relative humidity measured in accordance with ASTM D882.

7. The packaging article of claim 1 wherein the bottom web further comprises a second cellulose layer and a first polymeric layer disposed between the first cellulose layer and the second cellulose layer.

8. The packaging article of claim 7 wherein the first polymeric layer comprises at least 90 wt %, in relation to the total weight of the first polymeric layer, materials selected from the group consisting of polyolefins, ethylene/vinyl acetate copolymers, ionomers, ethylene/alkyl acrylate copolymer, ethylene/(meth)acrylic acid copolymers and blends thereof.

9. The packaging article of claim 1 wherein the bottom web has a cellulose grammage of 300-600 gram/m² as measured in accordance with ISO 536:2012.

10. The packaging article of claim 1 wherein the first cellulose layer of the bottom web comprises a fibrous cellulose material.

11. The packaging article of claim 1 wherein the bottom web has a thickness of between 400-800 μm.

12. The packaging article of claim 1 further comprising a food product disposed between the top web and the bottom web.

13. The packaging article of claim 1 wherein the packaging article is a vacuum skin package.

14. The packaging article of claim 1 wherein the bottom web comprises less than 15 wt % polymeric material as compared to the total weight of the bottom web.

15. The packaging article of claim 1 wherein the bottom web is a tray comprising:
a flange; and
a cavity for receiving a product.

16. A process for packaging a product comprising the steps of:
a. situating a product onto a semi-rigid thermoformable bottom web;
the bottom web being a multilayer structure comprising:
i. a first cellulose layer comprising a majority portion of cellulose based material; and
ii. a seal layer comprising a majority portion of polymeric material;
b. sealing a flexible top web to at least a portion of the seal layer of the bottom web
the bottom web comprising between 80-99.5 wt % cellulose based material and 0.5-20 wt % polymeric material as compared to the total weight of the bottom web.

17. The process for packaging a product according to claim 16 wherein the bottom web is tray comprising a flange; and a cavity for receiving the product and the step of sealing is done with a pressure differential to form a vacuum skin package wherein the top web is sealed to the flange and a portion of the cavity not covered by the product.

18. The process for packaging a product according to claim 16 wherein the bottom web has an oxygen transmission rate of at least 8,000 cc (STP)/m²/day/1 atm at 23° C. at 0% RH measured according to ASTM 3985.

19. A method for making a bottom web comprising the steps of:
a. providing a first semi-rigid thermoformable cellulose layer; and
b. coating a seal layer onto a surface of the first semi-rigid thermoformable cellulose layer to form a bottom web;
the first semi-rigid thermoformable cellulose layer comprising a majority portion of cellulose based material;
the seal layer comprising a majority portion of polymeric material;
the bottom web comprising between 80-99.5 wt % cellulose based material and 0.5-20 wt % polymeric material as compared to the total weight of the bottom web.

20. The method of claim 19 further comprising the steps of
a. providing a second semi-rigid thermoformable cellulose layer; and
b. extruding a polymeric layer between the first semi-rigid thermoformable cellulose layer and the second semi-rigid thermoformable cellulose layer to create a bottom web having at least two semi-rigid thermoformable cellulose layers.
